(19) United States
(12) Patent Application Publication
(10) Pub. No.: US 2009/0152205 A1
(43) Pub. Date: Jun. 18, 2009

(54) METHOD AND APPARATUS FOR PATHOGENIC AND CHEMICAL REDUCTION IN FLUID WASTE

(76) Inventor: Peter Klaptchuk, Regina (CA)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/301,453

(22) PCT Filed: Apr. 10, 2007
(86) PCT No.: PCT/CA2007/000601

§ 371 Date: Nov. 18, 2008

(30) Foreign Application Priority Data
Apr. 10, 2006 (CA) 2,542,673

(51) Int. Cl. C02F 1/78; C02F 103/00

(52) U.S. Cl. 210/744; 210/760; 210/96.1

(57) ABSTRACT

In a method of treating a substantially continuous flow of liquid waste in a series of decontamination tanks, the flow is directed into a tank and when liquid waste in the tank reaches a desired level the flow is directed into a next tank of the series. Ozone is bubbled through the waste in the tanks and the waste is agitated. When a disinfection period is complete in a tank, the treated liquid waste is drained into a disposal conduit that may be connected to a conventional sewer line. A sufficient number of decontamination tanks is provided such that a tank is available to receive the flow of liquid waste at all times.

This invention is in the field of waste treatment and in particular to a method of treating fluid waste and sewage generated from hospitals or other medical facilities with ozone and an apparatus for completing the disinfection.

### BACKGROUND

The treatment of fluid waste and sewage generated by hospitals, medical facilities, research facilities, and the like has become an important issue over the past decade. Economic, environmental and safety issues play a key role in the management of bio-hazardous waste from such facilities. Fluid waste including fluid blood, blood products and body fluids may contain pathogenic bacteria, viruses, parasites and fungi, which are hazardous to human and animal health. Such fluid waste commonly is flushed down toilets, or washed down plumbing drains in the facility and enters the regular sewage system of the municipality, city, or like jurisdiction in which the facility is located, with potential harmful consequences. Potentially harmful chemicals can also be present in sewage from certain facilities.

The use of ozone is well known as a disinfectant or sterilizing agent. Ozone is a powerful oxidizer which effectively kills microorganisms. Because of this activity and its cost effectiveness, ozone has been widely used in disinfection processes. Ozonation kills bacteria more rapidly than chlorine, it decomposes organic materials and it removes coloration in aqueous systems. Ozonation also breaks down chemicals such as cyanide, phenols, iron, manganese and detergents. Ozone applications in fluid treatments such as the sterilization of water and sewage treatment are well documented.

Ozone (O₃) is an unstable gas comprising three oxygen atoms. It is unstable because ozone gas will readily degrade back to its stable state, diatomic oxygen (O₂), the form of oxygen humans breathe to live, with the formation of free oxygen atoms or free radicals. The free oxygen atoms are highly reactive and will oxidize almost everything, including viruses, fungi, moulds, bacteria, parasites, organic and inorganic compounds. Ozone's high level of oxidation properties means that in addition to being a disinfectant, ozone is capable of eliminating odors. Ozone is considered an environmentally friendly disinfectant because it is a potent disinfectant at low concentrations, it does not produce any harmful residues or by-products and all residual ozone used in disinfection is converted back to normal oxygen within a relatively short period of time.

### SUMMARY OF THE INVENTION

It is an object of the present invention to provide a method and apparatus for the disinfection of bio-hazardous fluid waste and liquid sewage generated from various facilities that overcomes problems with current methods of disinfecting fluid bio-hazardous waste and sewage.

In a first embodiment the present invention provides a method of treating a substantially continuous flow of liquid waste in a series of decontamination tanks. The method comprises directing the flow of liquid waste into a decontamination tank of the series; when liquid waste in the decontamination tank reaches a desired level, stopping flow of liquid waste into the decontamination tank and directing the flow of liquid waste into a next decontamination tank of the series; agitating, and bubbling ozone through, liquid waste in each decontamination tank until the liquid waste therein is treated; when treatment is complete in a decontamination tank, draining the treated liquid waste from the completed decontamination tank into a disposal conduit; wherein a sufficient number of decontamination tanks is provided such that a decontamination tank is available to receive the flow of liquid waste at all times.

In a second embodiment the present invention provides a system for treating a substantially continuous flow of liquid waste. The system comprises a series of decontamination tanks, an input conduit carrying the flow of liquid waste, and a conduit network configured to direct the flow of liquid waste into any selected decontamination tank. An output conduit in each decontamination tank is connected to a disposal conduit, and an output valve is operative to open and close the output conduit. A full level sensor in each decontamination tank is operative to detect when a level of liquid waste in the decontamination tank reaches a desired level, and an empty level sensor in each decontamination tank is operative to detect when a level of liquid waste in the decontamination tank reaches a substantially empty level. An agitator in each decontamination tank is operative to agitate liquid waste, and an ozone bubbler in each decontamination tank is operative to bubble ozone through liquid waste. A controller is operative to operate the agitator and ozone bubbler, determine when treatment of liquid waste in a decontamination tank is complete and then open the output valve to drain liquid waste from the decontamination tank through the disposal conduit, receive information from each empty level sensor and close the output valve on a decontamination tank where the empty level sensor indicates the decontamination tank is substantially empty, and receive information from each full level sensor and stop flow of liquid waste into a decontamination tank when the desired level of liquid waste therein is reached, and operative to direct the flow of liquid waste into another of the series of decontamination tanks that is substantially empty.

The flow of liquid waste or sewage from the selected facility is directed into a series of decontamination reservoirs or tanks that are sequentially filled with liquid waste or sewage, treated with ozone for a time period as required, drained into the regular sewage system, and then filled again for the process to be repeated. The fluid waste flows from the facilities sewage system into a first decontamination tank until the tank is full, at which time a valve will shut off the flow to the first tank and direct the flow to a second tank, and when the second tank is full, the flow is directed to a third tank, and so on.

The fluid waste and sewage in the first tank are then agitated as an ozone generator bubbles ozone through the fluid waste to ensure thorough contact of the ozone with the microbial contaminants in the waste. Mechanical agitators and/or compressed air bubblers break up solids and stir the liquid waste with the ozone bubbles to encourage contact. The ozone level in the decontamination tank can be monitored by an ozone sensor and maintained at a concentration suitable for killing bacteria and like microbes according to the load of waste in the tank and according to the duration of the ozone exposure.

When the decontamination process is complete in the first tank, the decontaminated liquid waste will be discharged from tank into the normal sewage system, and the tank will again be empty and ready to receive and process new waste. The number of tanks, size of each tank, ozone concentration, and duration of treatment will be configured, considering the chemicals, pathogens, and the like present in the liquid waste being treated and the volume thereof, such that by the time the last available tank in the series has been filled with liquid waste, at least the first tank will be empty and ready to receive a new batch of liquid waste. A steady stream of all liquid waste from the facility can thus be treated in a batch process in each decontamination tank.

The agitation of the waste during the ozone treatment assists in the breaking up of any semi solid or gelatinous material that may be present and speeds up the process of chemical and microbial degradation. It is contemplated that the agitation of the waste may start as soon as waste begins to flow into the decontamination tank, which will further speed up the process of chemical and microbial decontamination of the waste.

It is contemplated that the generation of ozone may start when the tank is partially full of waste or it may not start until the tank is full of waste. When the required time for decontamination has elapsed based upon the ozone flow rate and tank size, and the fluid waste has been decontaminated, the decontaminated waste from the decontamination tank will be piped off and discharged into the usual sewage system.

The present invention provides a method and apparatus that allows for the continuous decontamination of fluid bio-hazardous waste and sewage by ozone decontamination and is relatively simple and environmentally friendly. Fluid waste or liquid sewage disinfected by this method produces no potentially harmful residues that could harm the environment or be harmful to humans or animals. The apparatus and method for practicing the invention is such that the same could be used in the treatment of liquid waste and sewage generated from intensive livestock operations, animal clinics or veterinary hospitals, animal research facilities, or any like facility where fluid waste is a concern.

The discharge of inert treated fluid waste into a municipal sewage system will somewhat reduce the normal bacterial load of the municipal treatment system, which bacteria is necessary for conventional sewage breakdown and treatment. However, it is contemplated that in most situations the percentage of total sewage represented by the inert sewage will be relatively small, and will not unduly upset the bacterial activity.

It is further contemplated that the system could be used to treat the discharge from a sewage treatment plant to kill bacteria and oxidize chemicals in the discharge stream prior to discharge into a river or the like.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic view of an embodiment of a decontamination tank with intake valve, discharge outlet, an ozone generating apparatus, an ozone sensor and agitator for practicing the invention;

FIG. 2 is a schematic view of a series of decontamination tanks illustrating a method of the invention for treating a substantially continuous flow of liquid waste in a series of decontamination tanks.

### DETAILED DESCRIPTION OF THE ILLUSTRATED EMBODIMENTS

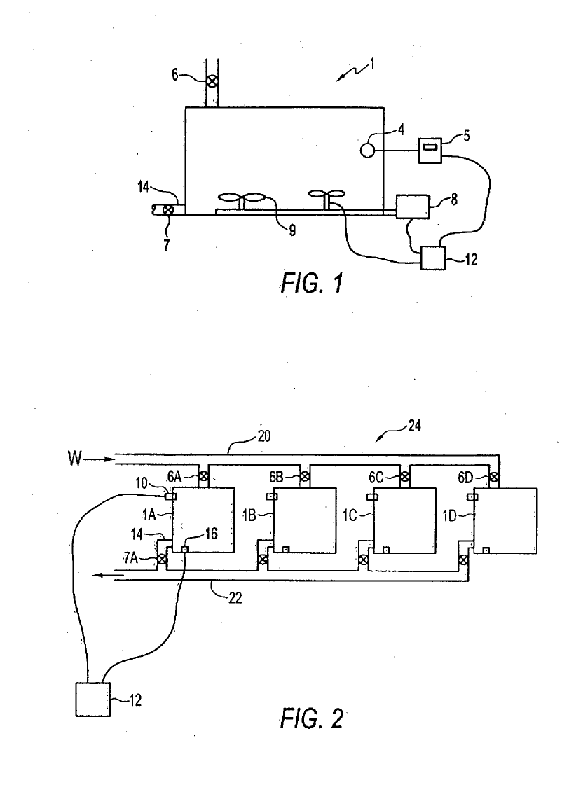

FIG. 1 illustrates a decontamination tank 1 with an ozone bubbler 8 of the invention operative to bubble ozone through the liquid waste sewage in tank 1 and mechanical agitators 9 operative to stir the sewage. The ozone concentration is sensed by an ozone sensor 4 and is remotely monitored on an indicator 5 connected to the sensor 4. A controller 12 is operative to operate the ozone bubbler to maintain ozone in the decontamination tank at a concentration suitable for treatment. The liquid waste enters tank 1 via inlet valve 6 and the decontaminated waste exits tank 1 via output conduit 14 and output valve 7.

The length of the disinfection period will depend upon the size of the load in the decontamination tank and can be varied such that different types of chemicals and pathogens that may be present in the waste, and which may be more or less resistant to inactivation, can be effectively inactivated during the ozone decontamination process. Based upon known studies, it will be readily determinable as to what combinations of time and ozone concentration will be appropriate to achieve the goal of the process to inactivate substantially all pathogens that may be present in the waste. The agitator 9 is operated during the disinfection period to ensure that the ozone maintains adequate contact with the fluid waste. The agitation will also assist in the breakdown of any solid material that may be present in the sewage. Compressed air can be bubbled through the sewage for further agitation as well.

When the disinfection period is over the decontaminated liquid waste is discharged via output valve 7 through disposal conduit 22. The controller 12 will typically be operative to control the operation of the ozone bubbler 8 and agitators 9. The same controller can be used to control flow of waste through the system.

FIG. 2 illustrates a series of decontamination tanks that schematically shows a system for treating a substantially continuous flow of liquid waste W, and demonstrate a method of the invention for treating a substantially continuous flow of liquid waste in a series of decontamination tanks. A substantially continuous flow of sewage or like liquid waste flows through input conduit 20 first into tank 1A. A conduit network 24 is configured to direct the flow of liquid waste W into any selected decontamination tank.

A full level sensor 10 in each decontamination tank is operative to detect when a level of liquid waste in the decontamination tank reaches a desired level, typically when the tank is full, and communicate that information to a controller 12. The controller 12 receives information from the full level sensor 10 and stops flow of liquid waste into the decontamination tank 1A when the desired level of liquid waste therein is reached, and directs the flow of liquid waste into another of the series of decontamination tanks that is substantially empty. Thus in the illustrated system, when tank 1A is full, valve 6A is closed, and valve 6B is opened and sewage flows into tank 1B and tank 1A is then treated for the required length of time as described above. This disinfection period of time will depend upon the size of the tank, amount of waste load and ozone flow rate which will be calculated based upon that testing to determine a safe period.

When the disinfection period is passed and treatment of the waste in the first decontamination tank 1A is complete, the controller 12 is operative to drain the treated liquid waste from the completed decontamination tank 1A through output conduit 14 into a disposal conduit 22 by opening output valve 7A. The disposal conduit 22 will typically be connected to discharge the treated waste into a conventional sewer system. Once the disinfection period has passed the controller 12 can turn off the agitators 9 and ozone bubbler 8, or leave the agitators 9, or the ozone bubbler as well, operating for some time to keep the waste stirred as it drains.

An empty level sensor 16 in each decontamination tank is operative to detect when a level of liquid waste in the decontamination tank reaches a substantially empty level. The controller is operative to receive information from the empty level sensor 16 and close the output valve 7A on the decontamination tank 1A when the empty level sensor 16 indicates the decontamination tank 1A is substantially empty.

When tank 1B is full, the valve 6B is closed, and valve 6C is opened and waste flows into tank 1C and the decontamination process carries on in tank 1B and the sewage flows into tank 1C, until same is full and valve 6C is closed and valve 6D opened such that sewage flows into tank 1D. The number of tanks will be based upon liquid waste flow rate, tank capacity, plus safety factor and the treatment period. There must be enough tanks available such that a decontamination tank is available to receive the flow of liquid waste at all times. Liquid waste continues to flow into other tanks until the waste in the first tank 1A is treated and discharged through the disposal conduit 22 via discharge outlet valve 7A and the empty tank 1A can then receive the flow of liquid waste and the process is repeated in the other decontamination tanks.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method of treating a substantially continuous flow of liquid waste in a series of decontamination tanks, the method comprising:
directing the flow of liquid waste into a decontamination tank of the series;
when liquid waste in the decontamination tank reaches a desired level, stopping flow of liquid waste into the decontamination tank and directing the flow of liquid waste into a next decontamination tank of the series;
agitating, and bubbling ozone through, liquid waste in each decontamination tank until the liquid waste therein is treated;
when treatment is complete in a decontamination tank, draining the treated liquid waste from the completed decontamination tank into a disposal conduit;
wherein a sufficient number of decontamination tanks is provided such that a decontamination tank is available to receive the flow of liquid waste at all times.

2. The method of claim 1 wherein completion of treatment in a decontamination tank is determined by time.

3. The method of claim 2 wherein a treatment is completed after a disinfection period determined by testing the liquid waste periodically with a known rate of ozone injection bubbling through liquid waste at the desired level in a decontamination tank.

4. The method of claim 1 wherein the agitation is operative to break up solids and stir the liquid waste with ozone bubbles to encourage contact between the liquid waste and the ozone.

5. The method of claim 1 comprising agitating the liquid waste with one of a mechanical agitator and a compressed air bubbler.

6. The method of anyone of claims 1-5 comprising monitoring a concentration of ozone in the decontamination tanks and maintaining ozone at a concentration suitable for treatment.

7. The method of claim 1 wherein the disposal conduit is connected to direct the treated liquid waste into a municipal sewage disposal system.

8. A system for treating a substantially continuous flow of liquid waste, the system comprising:
a series of decontamination tanks;
an input conduit carrying the flow of liquid waste and a conduit network configured to direct the flow of liquid waste into any selected decontamination tank;
an output conduit in each decontamination tank, the output conduit connected to a disposal conduit, and an output valve operative to open and close the output conduit;
a full level sensor in each decontamination tank operative to detect when a level of liquid waste in the decontamination tank reaches a desired level;
an empty level sensor in each decontamination tank operative to detect when a level of liquid waste in the decontamination tank reaches a substantially empty level;
an agitator in each decontamination tank operative to agitate liquid waste;
an ozone bubbler in each decontamination tank operative to bubble ozone through liquid waste;
a controller operative to:
operate the agitator and ozone bubbler;
determine when treatment of liquid waste in a decontamination tank is complete and then open the output valve to drain liquid waste from the decontamination tank through the disposal conduit;
receive information from each empty level sensor and close the output valve on a decontamination tank where the empty level sensor indicates the decontamination tank is substantially empty;
receive information from each full level sensor and stop flow of liquid waste into a decontamination tank when the desired level of liquid waste therein is reached, and operative to direct the flow of liquid waste into another of the series of decontamination tanks that is substantially empty.

9. The system of claim 8 wherein the controller is operative to stop the agitator and ozone bubbler when treatment of liquid waste in the corresponding decontamination tank is complete.

10. The system of claim 8 wherein the controller determines when treatment of liquid waste in a decontamination tank is complete by determining when a time equal to a disinfection period has passed, wherein the disinfection period is determined by testing the liquid waste periodically with a known rate of ozone injection bubbling through liquid waste at the desired level in a decontamination tank.

11. The system of claim 8 wherein the agitator is operative to break up solids and stir the liquid waste with ozone bubbles to encourage contact between the liquid waste and the ozone.

12. The system of claim 8 wherein the agitator is provided by at least one of a mechanical agitator and a compressed air bubbler.

13. The system of claim 8 comprising a sensor operative to display a concentration of ozone in a decontamination tank and wherein the controller is operative to operate the ozone bubbler to maintain ozone in the decontamination tank at a concentration suitable for treatment.
